(19) United States
(12) Patent Application Publication
(10) Pub. No.: US 2025/0084807 A1
(43) Pub. Date: Mar. 13, 2025

(54) DOUBLE-PASSAGE BALANCE STRUCTURE OF CARBURETOR

(71) Applicant: Zhejiang Ruixing Electromechanical Technology Co., Ltd., Wenzhou (CN)

(72) Inventors: Yan XU, Wenzhou (CN); Qi'an CHEN, Wenzhou (CN); Pingfan MO, Wenzhou (CN)

(73) Assignee: Zhejiang Ruixing Electromechanical Technology Co., Ltd., Wenzhou (CN)

(21) Appl. No.: 18/825,457

(22) Filed: Sep. 5, 2024

(30) Foreign Application Priority Data
Sep. 9, 2023 (CN) 202311159145.1

(51) Int. Cl. F02M 7/11; F02M 5/08

(52) U.S. Cl. CPC F02M 7/11; F02M 5/08

(57) ABSTRACT

A double-passage balance structure of a carburetor includes a carburetor body and a float chamber composed of the carburetor body and a housing; the carburetor body is provided with balance passages and a through cavity for the air to enter and mix with a fuel and for a mixture to be output, the balance passages include A and second balance passages, openings of the A and second balance passages in the float chamber are staggered in an axial direction and a radial direction of the cavity, and the opening of the first balance passage in the float chamber is higher than the opening of the second balance passage in the float chamber; and other ends of the A and second balance passages are both communicated with a converging passage provided in the carburetor body, and the converging passage is communicated with the atmosphere.

### CROSS-REFERENCE TO RELATED APPLICATIONS

This application claims priority to Chinese Patent Application No. 202311159145.1, filed on Sep. 9, 2023, the content of which is incorporated herein by reference in its entirety.

### TECHNICAL FIELD

The present application relates to the field of carburetors, and in particular, to a double-passage balance structure of a carburetor.

### BACKGROUND

As shown in FIG. 1, in a carburetor fuel supply system used in a general engine, a carburetor generally has a carburetor body 1′ and a housing 3′ connected to a lower portion thereof, a float chamber is formed between the carburetor body 1′ and the housing 3′, a float is provided in the float chamber to control a fuel level, the carburetor body 1′ is provided with a through cavity 4′ for the air to enter and mix with a fuel and a mixture to be output, a throttle choke is provided at an air inlet end of the cavity 4′, a throttle is provided at a mixture output end, and a mixing chamber in which a fuel and the air are mixed is provided in the middle of the cavity 4′. In the prior art, the carburetor body 1′ of such a carburetor is generally provided with only one balance hole 2′, one end thereof is communicated with a top of the float chamber, and the other end thereof is open to an end face of a throttle end flange 5′ and is communicated with the atmosphere, and normally functions to balance a pressure in the float chamber. When the engine is in a state of tilting radially relative to the cavity 4′ or overturning axially relative to the cavity during use or shutdown maintenance, if the state of tilting or overturning causes the balance hole to face downward, the fuel in the float chamber will directly leak from the balance hole 2′. If the state of tilting or overturning causes the fuel in the float chamber to submerge the balance hole 2′, that is, when the opening of the balance hole 2′ in the float chamber is below the fuel level, the pressure in the float chamber increases due to gasification of gasoline and cannot be balanced, so that the fuel will still leak from the balance hole 2′ under the action of the pressure in the float chamber, which not only poses a safety risk, but also pollutes the environment.

### SUMMARY

The object of the present application is to provide a double-passage balance structure of a carburetor, which solves the problems in the prior art.

In order to achieve the above object, the present application provides the following technical solution: a double-passage balance structure of a carburetor includes a carburetor body and a float chamber composed of the carburetor body and a housing, and the carburetor body is provided with balance passages and a through cavity for the air to enter and mix with a fuel and for a mixture to be output, where the balance passages include an first balance passage and a second balance passage, openings of the first balance passage and the second balance passage in the float chamber are staggered in an axial direction and a radial direction of the cavity, and the opening of the first balance passage in the float chamber is higher than the opening of the second balance passage in the float chamber, other ends of the first balance passage and the second balance passage are both communicated with a converging passage provided in the carburetor body, and the converging passage is communicated with the atmosphere.

Further, the first balance passage includes a first communication hole, a first groove and a first connection hole which are communicated with each other, and the second balance passage includes a second communication hole, a second groove and a second connection hole which are communicated with each other; the first groove and the second groove are both provided on an end face of a choke end flange of the carburetor body and are respectively located on both radial sides of the cavity, the first communication hole is located above the cavity and extends axially along the cavity, and one end thereof is open to the float chamber and the other end thereof is open to one end of the first groove; the second communication hole is located on one side of the cavity and extends axially along the cavity, and one end thereof is open to the float chamber and a position of the opening is at least higher than an interface between a float and the fuel in the float chamber, and the other end thereof is open to one end of the second groove; the converging passage is arranged in the middle of the carburetor body, other ends of the first groove and the second groove are respectively communicated with the converging passage through the first connection hole and the second connection hole; and the double-passage balance structure of the carburetor further includes a seal which covers the end face of the choke end flange, and the seal covers and seals openings of the first groove and the second groove.

Further, the opening of the first balance passage in the float chamber is located on one side of the cavity and away from one end of the choke end flange, and the opening of the second balance passage in the float chamber is located on the other side of the cavity and close to one end of the choke end flange; and the openings of the first balance passage and the second balance passage in the float chamber are respectively located on both sides of an axis of the housing.

Further, an open end of the converging passage is provided with an extension adapter.

Beneficial effects of the present application: the double-passage balance structure of the carburetor provided by the present application includes two balance passages, the openings of the two balance passages in the float chamber are staggered in the axial direction and the radial direction of the cavity, and the opening of the first balance passage in the float chamber is higher than the opening of the second balance passage in the float chamber; and since an inner space of the float chamber is a structure with a small bottom and a large top, and the fuel level in the float chamber is adapted to a position of the float, when the carburetor provided with the double-passage balance structure of the present technical solution tilts radially relative to the cavity or overturns axially relative to the cavity, there will always be at least one balance passage with the opening higher than the fuel level in the float chamber, so that an interior of the float chamber is communicated with the atmosphere to balance the internal pressure; and at the same time, an outlet of the converging passage or a highest point of the two balance passages will always be higher than the fuel level in the float chamber, which effectively avoids leakage of the fuel from the converging passage through the balance passages, and has significant safety and environmental protection effects.

### BRIEF DESCRIPTION OF THE DRAWINGS

FIG. 1 is a structural schematic diagram of a carburetor and first balance hole in the prior art.

FIG. 2 is a schematic diagram of a double-passage balance structure of a carburetor of the present application (with a seal being removed).

FIG. 3 is a partial cross-sectional view of the double-passage balance structure of the carburetor of the present application.

FIG. 4 is a schematic diagram of the double-passage balance structure of the carburetor of the present application in a state of tilting to one side (with the seal being removed).

FIG. 5 is a schematic diagram of the double-passage balance structure of the carburetor of the present application in a state of tilting to the other side (with the seal being removed).

FIG. 6 is a schematic diagram of the double-passage balance structure of the carburetor of the present application in a state of overturning (with the seal being removed).

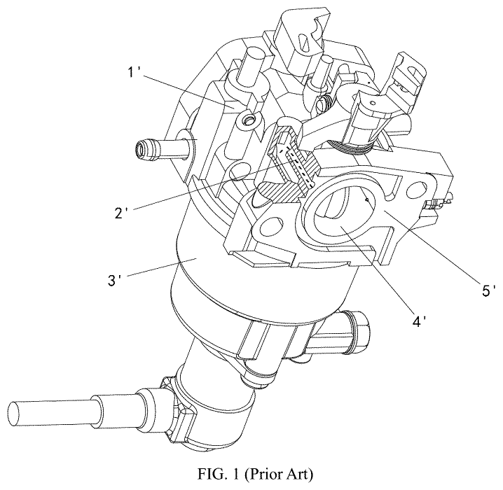

### DETAILED DESCRIPTION OF THE EMBODIMENTS

The technical solutions of the embodiments of the present application will be described clearly and completely below with reference to the accompanying drawings in the embodiments of the present application, and it is obvious that the embodiments described are only some, instead of all, of the embodiments of the present application. All other embodiments obtained by those of ordinary skill in the art based on the embodiments of the present application without creative efforts fall within the protection scope of the present application.

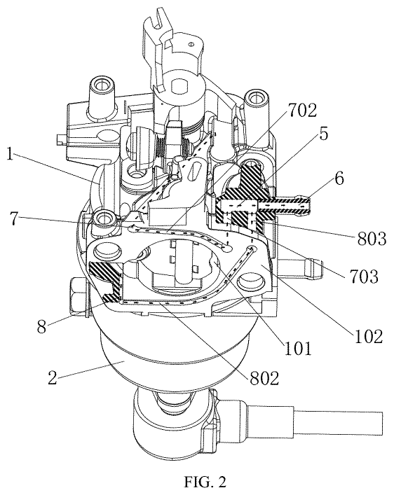

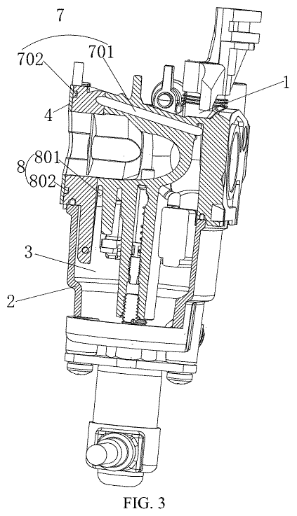

With reference to FIGS. 2 to 6, a double-passage balance structure of a carburetor includes a carburetor body 1 and a float chamber 3 composed of the carburetor body 1 and a housing 2, and the carburetor body 1 is provided with balance passages and a through cavity 101 for the air to enter and mix with a fuel 9 and for a mixture to be output, where the balance passages include an first balance passage 7 and a second balance passage 8, openings of the first balance passage 7 and the second balance passage 8 in the float chamber 3 are staggered in an axial direction and a radial direction of the cavity 101, and the opening of the first balance passage 7 in the float chamber 3 is higher than the opening of the second balance passage 8 in the float chamber 3, other ends of the first balance passage 7 and the second balance passage 8 are both communicated with a converging passage 5 provided in the carburetor body 1, and the converging passage 5 is communicated with the atmosphere.

Preferably, the first balance passage 7 includes a first communication hole 701, a first groove 702 and a first connection hole 703 which are communicated with each other, and the second balance passage 8 includes a second communication hole 801, a second groove 802 and a second connection hole 803 which are communicated with each other; the first groove 702 and the second groove 802 are both provided on an end face of a choke end flange 102 of the carburetor body 1 and are respectively located on both radial sides of the cavity 101, the first communication hole 701 is located above the cavity 101 and extends axially along the cavity 101, and one end thereof is open to the float chamber 3 and the other end thereof is open to one end of the first groove 702; the second communication hole 801 is located on one side of the cavity 101 and extends axially along the cavity 101, and one end thereof is open to the float chamber 3 and a position of the opening is at least higher than an interface between a float and the fuel 9 in the float chamber 3, and the other end thereof is open to one end of the second groove 802; the converging passage 5 is arranged in the middle of the carburetor body 1, other ends of the first groove 702 and the second groove 802 are respectively communicated with the converging passage 5 through the first connection hole 703 and the second connection hole 803; and the double-passage balance structure of the carburetor further includes a seal 4 which covers the end face of the choke end flange 102, and the seal 4 covers and seals openings of the first groove 702 and the second groove 802. Here, the seal 4 can be a sealing cover plate only used for covering and sealing the openings of the first groove 702 and the second groove 802, and can also be a sealing gasket used when the carburetor is connected to an engine. As such, when the carburetor is connected to the engine, the openings of the first groove 702 and the second groove 802 located on the end face of the choke end flange 102 are naturally covered and sealed, so that the first balance passage 7 and the second balance passage 8 respectively form a complete passage.

Here, the significance of providing the first groove 702 and the second groove 802 on the end face of the choke end flange 102 of the carburetor body 1 lies in two aspects. On the one hand, the first groove 702 and the second groove 802 can be directly cast and formed during casting of the carburetor body 1 to save raw materials and reduce machining workload. On the other hand, it is convenient to machine the first communication hole 701, the second communication hole 801, the first connection hole 703 and the second connection hole 803, which simplifies the difficulty of machining process and improves production efficiency.

Preferably, the opening of the first balance passage 7 in the float chamber 3 is located on one side of the cavity 101 and away from one end of the choke end flange 102, and the opening of the second balance passage 8 in the float chamber 3 is located on the other side of the cavity 101 and close to one end of the choke end flange 102; and the openings of the first balance passage 7 and the second balance passage 8 in the float chamber 3 are respectively located on both sides of an axis of the housing 2.

Further preferably, an open end of the converging passage 5 is provided with an extension adapter 6. This extension pipe 6 can, on the one hand, allows the carburetor to tilt in one direction so that a mouth surface thereof is much higher than the fuel level in the float chamber 3, and on the other hand, can also be connected to a pipe for recycling oil vapor.

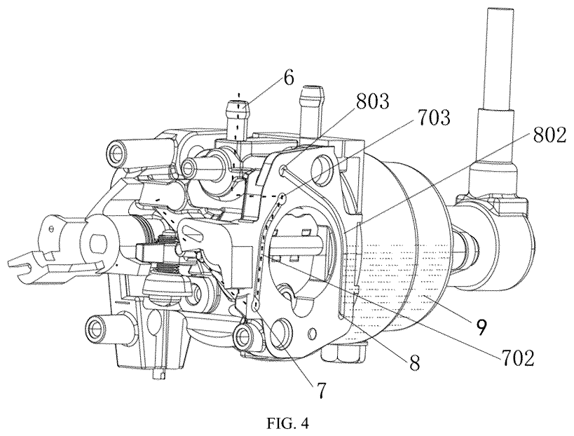

With the above arrangement, and with particular reference to FIGS. 4-6, the anti-leakage principle of the present application is as follows: as shown in FIG. 4, the carburetor is in a limit state of radially tilting to one side along the cavity 102, at this time, a mouth end of the extension adapter 6 is vertically facing upward. In this state, the opening of the second balance passage 8 in the float chamber 3 is located below the fuel level, and the second balance passage 8 cannot be communicated with the atmosphere for balance, and at this time, the opening of the first balance passage 7 in the float chamber 3 is higher than the fuel level. That is, the float chamber 3 can be communicated with the atmosphere through the first balance passage 7 to balance the pressure in the float chamber 3, and at the same time, the first connection hole 703, the second connection hole 803 and an outlet end of the converging passage 5 are also higher than the fuel level in the float chamber 3, which effectively avoids leakage of the fuel 9 in the float chamber 3 along the second balance passage 8.

As shown in FIG. 5, the carburetor is in a limit state of radially tilting to the other side along the cavity 102, at this time, the mouth end of the extension adapter 6 is vertically facing downward. In this state, the opening of the first balance passage 7 in the float chamber 3 is located below the fuel level, and the first balance passage 7 cannot be communicated with the atmosphere for balance, and at this time, the opening of the second balance passage 8 in the float chamber 3 is higher than the fuel level. That is, the float chamber 3 can be communicated with the atmosphere through the second balance passage 8 and the converging passage 5 to balance the pressure in the float chamber 3. At the same time, a communication opening of the first communication hole 701 of the first balance passage 7 in the first groove 702 and a communication opening of the second communication hole 801 of the second balance passage 8 in the second groove 802 are both higher than the fuel level in the float chamber 3, which can also effectively avoid the leakage of the fuel 9 in the float chamber 3 along the first balance passage 7.

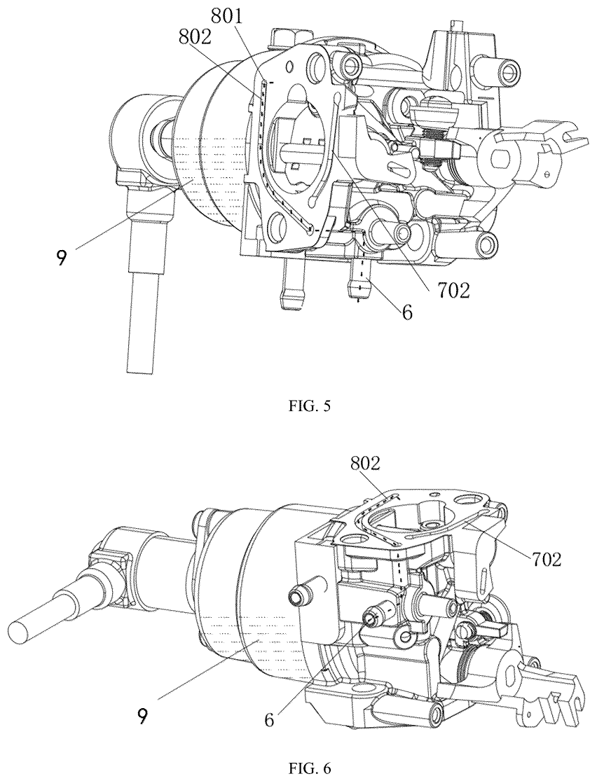

As shown in FIG. 6, the carburetor is in a limit state of axially overturning to one side along the cavity 102, at this time, the mouth end of the extension adapter 6 is at a horizontal position. In this state, the opening of the first balance passage 7 in the float chamber 3 is located below the fuel level, and the first balance passage 7 cannot be communicated with the atmosphere for balance, and at this time, the opening of the second balance passage 8 in the float chamber 3 is higher than the fuel level. That is, the float chamber 3 can be communicated with the atmosphere through the second balance passage 8 and the converging passage 5 to balance the pressure in the float chamber 3. At the same time, positions of the first groove 702 and the second groove 802 are both higher than the fuel level in the float chamber, which also effectively avoids the leakage of the fuel 9 in the float chamber 3 along the first balance passage 7. Similarly, when the carburetor is in a limit state of axially overturning to the other side along the cavity 102, that is, the positions of the first groove 702 and the second groove 802 face downward, the first balance passage 7 can be communicated with the atmosphere to balance the pressure in the float chamber, and the mouth end of the extension adapter 6 is located at the horizontal position in the middle of the carburetor body 1 and is also higher than the fuel level in the float chamber, which also effectively avoids the leakage of the fuel 9 in the float chamber 3 along the second balance passage 8.

It should be noted here that the existing carburetor float chambers are all structures with small bottoms and large tops, the fuel 9 is stored in s lower portion of the float chamber in the normal position, and the fuel level in the float chamber is always lower than an upper surface of the float, so that the fuel 9 stored in the float chamber 3 will be received by a corresponding portion of the float chamber when the carburetor is in the limit state of tilting or overturning shown in FIGS. 4-6, and the fuel level will not reach a higher one of the openings of the first balance passage 7 or the second balance passage 8 in the float chamber 3.

It is noted that relational terms such as first and second, and the like, may be used herein to distinguish one entity or action from another entity or action without necessarily requiring or implying any actual such relationship or order between such entities or actions. Furthermore, the terms “include”, “including”, or any other variation thereof, are intended to cover a non-exclusive inclusion, such that a process, a method, an article, or an apparatus that includes a series of elements not only includes those elements but also may include other elements not expressly listed or inherent to such process, method, article, or apparatus.

In the description of the present application, it should be understood that the terms “upper”, “lower”, “left”, “right”, “top”, “bottom”, and the like indicate orientations or positional relationships based on the orientations or positional relationships shown in the drawings, and are only for convenience of description and simplification of description, but do not indicate or imply that the device or unit indicated must have a specific direction, be constructed and operated in a specific orientation, and therefore, should not be construed as limiting the present application.

While embodiments of the present application have been shown and described, it will be understood by those of ordinary skill in the art that various changes, modifications, substitutions and alterations can be made to the embodiments without departing from the principles and spirit of the present application, and the scope of which is defined by the claims and their equivalents.

What is claimed is:

1. A double-passage balance structure of a carburetor, comprising a float chamber composed of a carburetor body and a housing, and the carburetor body being provided with balance passages and a through cavity for the air to enter and mix with a fuel and for a mixture to be output, wherein
the balance passages comprise an first balance passage and a second balance passage, openings of the first balance passage and the second balance passage in the float chamber are staggered in an axial direction and a radial direction of the cavity, and the opening of the first balance passage in the float chamber is higher than the opening of the second balance passage in the float chamber; and
other ends of the first balance passage and the second balance passage are both communicated with a converging passage provided in the carburetor body, and the converging passage is communicated with the atmosphere.

2. The double-passage balance structure of the carburetor according to claim 1, wherein the first balance passage comprises a first communication hole, a first groove and a first connection hole which are communicated with each other, and the second balance passage comprises a second communication hole, a second groove and a second connection hole which are communicated with each other;
the first groove and the second groove are both provided on an end face of a choke end flange of the carburetor body and are respectively located on both radial sides of the cavity, the first communication hole is located above the cavity and extends axially along the cavity, and one end thereof is open to the float chamber and the other end thereof is open to one end of the first groove;
the second communication hole is located on one side of the cavity and extends axially along the cavity, and one end thereof is open to the float chamber and a position of the opening is at least higher than an interface between a float and the fuel in the float chamber, and the other end thereof is open to one end of the second groove;
the converging passage is arranged in the middle of the carburetor body, other ends of the first groove and the second groove are respectively communicated with the converging passage through the first connection hole and the second connection hole; and the double-passage balance structure of the carburetor further comprises a seal which covers the end face of the choke end flange, and the seal covers and seals openings of the first groove and the second groove.

3. The double-passage balance structure of the carburetor according to claim 1, wherein the opening of the first balance passage in the float chamber is located on one side of the cavity and away from one end of the choke end flange, and the opening of the second balance passage in the float chamber is located on the other side of the cavity and close to one end of the choke end flange; and the openings of the first balance passage and the second balance passage in the float chamber are respectively located on both sides of an axis of the housing.

4. The double-passage balance structure of the carburetor according to claim 1, wherein an open end of the converging passage is provided with an extension adapter.
